(19) United States
(12) Patent Application Publication
(10) Pub. No.: US 2010/0097894 A1
(43) Pub. Date: Apr. 22, 2010

(54) DETECTION-SIGNAL TRANSMITTING APPARATUS

(76) Inventors: Osamu Kubota, Saitama (JP); Takayuki Yui, Saitama (JP); Hideo Hurukawa, Saitama (JP); Haruhiko Ueno, Saitama (JP)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/997,802

(22) PCT Filed: Aug. 1, 2006
(86) PCT No.: PCT/JP2006/315218

§ 371 Date: Feb. 4, 2008

(30) Foreign Application Priority Data
Aug. 4, 2005 (JP) 2005-226750

(51) Int. Cl. G10K 11/00; H02J 17/00; H01Q 7/00

(52) U.S. Cl. 367/197; 307/104; 343/866

(57) ABSTRACT

To enable detection and transmission of an ultrasonic signal with a high S/N ratio without any need for a component requiring high machining precision or high precision in mounting a component.

In a dresser head 41, an ultrasonic sensor 21 detecting an ultrasonic wave is provided, and further provided are: a signal converting/transmitting circuit 23 converting a detected signal of the ultrasonic sensor 21 to a digital signal and subjecting the digital signal to radio modulation; and a signal transmission antenna 26 to which the signal resulting from the radio modulation by the signal converting/transmitting circuit 23 is applied. Further, near the dresser head 41, a signal reception antenna 34 receiving a signal emitted by the signal transmission antenna 26 and a signal reception head 35 demodulating the reception signal obtained by the signal reception antenna 26 are provided, and the demodulated signal is output as a digital signal or an analog signal in a predetermined signal format via a control part 31.

### BACKGROUND OF THE INVENTION

1. Field of the Invention

The present invention relates to an apparatus which detects and transmits an ultrasonic signal generated during a dressing work, machining of a work, and the like, for the purpose of, for example, position control of a tool, and more particularly, to the apparatus with improved noise proof, improved reliability, and the like.

2. Description of the Related Art

As an apparatus of this type, there has been conventionally proposed, for example, an apparatus capable of detecting an ultrasonic wave which is generated when a grinding wheel in a grinding apparatus and a work come into contact with each other as disclosed, for example, in European Patent Application Publication No. 446849. Specifically, the publication document discloses an apparatus in which a piezoelectric element is attached to a grinding wheel, a first coil is connected in series to the piezoelectric element, and a second coil is disposed on a center axis of the first coil to face the first coil, so that an ultrasonic signal detected by the piezoelectric element can be obtained on the second coil side owing to electromagnetic coupling between the first coil and the second coil.

However, the above-described conventional apparatus is structured such that an output signal of the piezoelectric element is applied directly to the first coil and an induced signal corresponding to the output signal of the piezoelectric element s obtained at the second coil owing to the electromagnetic coupling with the second coil, and thus has a problem that the apparatus is extremely vulnerable to the influence of external electric noise and a high S/N ratio cannot be ensured.

Further, the level of the output signal of the piezoelectric element applied to the first coil is weak, and therefore, in order to obtain a sufficient induced electromotive force at the second coil, it is necessary for the first coil and the second coil to be close to each other at a small interval and to be disposed with highly accurate coaxiality. Therefore, component machining with as small a dimension error as possible is required, which has posed a problem of an increase in price of the apparatus.

### SUMMARY OF THE INVENTION

The present invention was made in consideration of the above circumstances, and an object thereof is to provide a detection-signal transmitting apparatus capable of detecting an ultrasonic signal with a high S/N ratio without requiring high precision in machining a component or high precision in mounting the component.

It is another object of the present invention to provide a detection-signal transmitting apparatus whose component attached to a rotating body to detect an ultrasonic wave from the rotating body little wears away and accordingly does not require periodic replacement.

According to an embodiment of the present invention, there is provided a detection-signal transmitting apparatus detecting and transmitting an ultrasonic wave generated in a rotating body,

the apparatus comprising, in the rotating body: an ultrasonic sensor detecting the ultrasonic wave; an analog/digital converter converting a detected signal of the ultrasonic sensor to a digital signal; a signal converting/transmitting circuit subjecting an output signal of the analog/digital converter to radio modulation; a signal transmission antenna emitting the signal resulting from the radio modulation by the signal converting/transmitting circuit; a power reception antenna receiving a power signal with a radio frequency transmitted from an external part; and a rectifying circuit rectifying the signal obtained by the power reception antenna to supply power, and

the apparatus further comprising: a signal reception antenna receiving the signal emitted from the signal transmission antenna; a signal reception head performing demodulation and signal level conversion of the reception signal obtained by the signal reception antenna; a power transmission head generating the power signal with the radio frequency; a power transmission antenna emitting the power signal with the radio frequency applied from the power transmission head; and a control part controlling operations of the signal reception head and the power transmission head and performing signal conversion,

wherein the signal transmission antenna and the power reception antenna are each composed of a core member formed in an annular shape and a coil winding wound around the core member and are disposed in a stacked manner, and

wherein the power transmission antenna is provided near an outer peripheral edge of the power reception antenna.

### BRIEF DESCRIPTION OF THE DRAWINGS

FIG. 1 is a structure view showing a rough structure example of a grinding apparatus in which a detection-signal transmitting apparatus of an embodiment of the present invention is realized;

FIG. 2 is a block diagram showing a first structure example mainly of electric structure portions of the detection-signal transmitting apparatus of the embodiment of the present invention;

FIG. 3 is a schematic view schematically showing a layout and structure example mainly of a power reception antenna, a signal reception antenna, a power transmission antenna, and a signal reception antenna of the present invention;

FIG. 4 is an enlarged schematic view schematically showing, in an enlarged manner, especially a portion where the power reception antenna, the signal transmission antenna, and the power transmission antenna in the schematic view shown in FIG. 3 are disposed;

FIG. 5 is a front view of a power transmission core member included in the power transmission antenna in the schematic view shown in FIG. 3;

FIG. 6 is a structure view schematically showing a second structure example of the detection-signal transmitting apparatus.

### DETAILED DESCRIPTION OF THE PREFERRED EMBODIMENTS

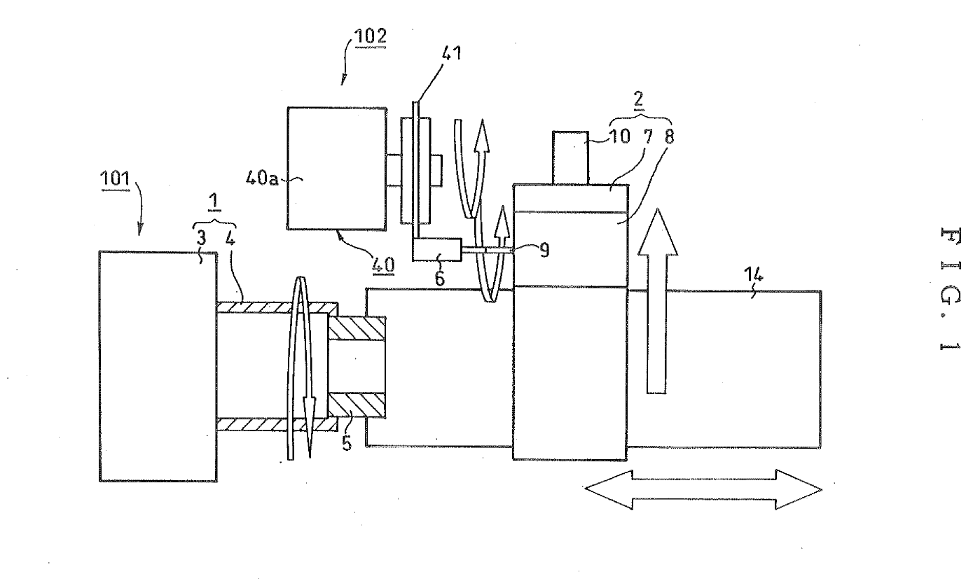

Hereinafter, an embodiment of the present invention will be described with reference to FIG. 1 to FIG. 6.

It should be noted that members, arrangement, and so on described below are not intended to limit the present invention, and can be variously modified within the scope of the spirit of the present invention.

First, a rough structure example of a grinding apparatus in which a detection-signal transmitting apparatus of the embodiment of the present invention is realized will be described with reference to FIG. 1.

This grinding apparatus basically has the same structure as an apparatus with a conventionally and publicly known structure except in that the later-described detection-signal transmitting apparatus is added. Incidentally, in FIG. 1, the illustration of the detection-signal transmitting apparatus is omitted.

The grinding apparatus of the embodiment of the present invention is divided mainly into a grinding section 101 and a dresser section 102.

The grinding section 101 includes, as its main constituent elements, a work holding part 1 to which a work 5 is attached, and a wheel holding part 2 to which a grinding wheel 6 is attached to be movable relative to the work 5, and the work 5 is machined by the grinding wheel 6 here.

The work holding part 1 includes: a body portion 3 fixedly attached to a base part fixed to a not-shown installation surface; and a rotation-side chuck 4 provided in the body portion 3 to be rotatable by a not-shown motor.

In the rotation-side chuck 4, at least a portion protruding from the body portion 3 is formed roughly in a hollow cylindrical shape, and the work 5 is detachably attached to a tip portion of the protruding portion.

The wheel holding part 2 includes a slide 7 to which the grinding wheel 6 is attached, as will be described next.

Specifically, a wheel spindle 8 to which the grinding wheel 6 is attached is provided on the slide 7 to be rotatable by a not-shown motor. The grinding wheel 6 is detachably attached to one end side of a wheel shaft 9, and the other end side of the wheel shaft 9 is inserted in the wheel spindle 8.

The slide 7 is provided to be movable on a field table 14 relative to the work 5 when driven by an infeed motor 10, and the movement of the field table 14 is controlled by NC control of a not-shown motor. Further, the slide 7 is provided to be rotatable on the field table 14, and the wheel spindle 8 is provided to be rotatable on the slide 7.

The dresser section 102 includes a dresser motor 40 and a dresser head 41 as its main constituent elements and is capable of dressing the grinding wheel 6.

The dresser head 41 formed in a disk shape is provided to be rotatable by the dresser motor 40.

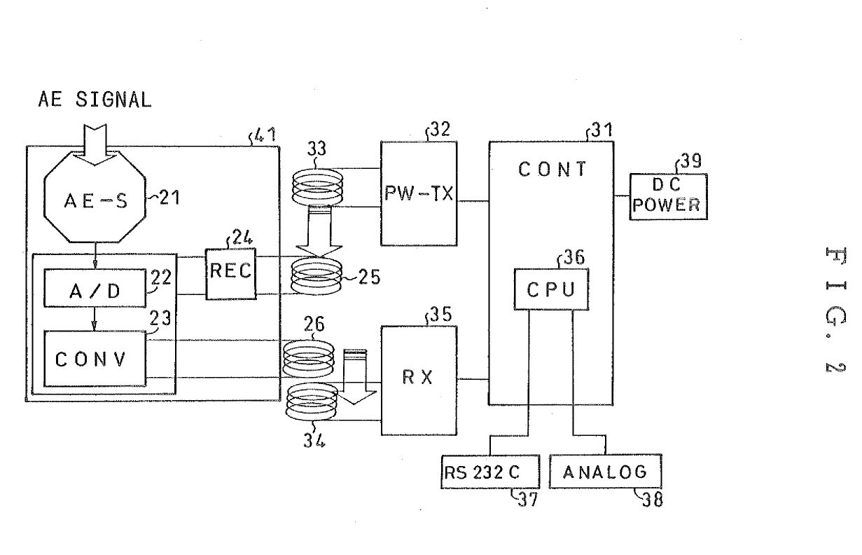

Next, an electric structure example of the detection-signal transmitting apparatus of the embodiment of the present invention realized in the above-described grinding apparatus will be mainly described with reference to FIG. 2.

The detection-signal transmitting apparatus of the embodiment of the present invention detects and transmits an ultrasonic signal generated in a dressing work, and by using a radio wave as a medium, the apparatus is capable of supplying power to later-described electronic circuits disposed in the dresser head 41 and transmitting, to an external part, a detected signal of an ultrasonic sensor (denoted by “AE-S” in FIG. 2) 21 digitally converted in the dresser head 41.

Concretely, in the dresser head 41, the ultrasonic sensor 21 is provided as described above, and an analog/digital converter (denoted by “A/D” in FIG. 2) 22, a signal converting/transmitting circuit (denoted by “CONV” in FIG. 2) 23, a rectifying circuit (denoted by “REC” in FIG. 2) 24, a power reception antenna 25, and a signal transmission antenna 26 are provided, as will be described later. Incidentally, the power reception antenna 25 and the signal transmission antenna 26 are disposed in the dresser head 41 in the embodiment of the present invention as will be described later, though shown outside the dresser head 41 in FIG. 2 for convenience sake in order to show a relation with a power transmission antenna 33 and a signal reception antenna 34 which will be described next.

Further, near the dresser head 41, a control part (denoted by “CONT” in FIG. 2) 31, a power transmission head (denoted by “PW-TX” in FIG. 2) 32, the power transmission antenna 33, the signal reception antenna 34, a signal reception head (denoted by “RX” in FIG. 2) 35, and so on are disposed as will be described later.

The ultrasonic sensor 21 is, for example, a conventionally and publicly known one using a piezoelectric element.

The analog/digital converter 22 is connected to the ultrasonic sensor 21, and a detected ultrasonic signal which is generated when the dresser head 41 and the grinding wheel 6 come into contact with each other and which is obtained by the ultrasonic sensor 21 is directly converted to a digital signal, and the digital signal is output to the signal converting/transmitting circuit 23 which will be described next.

The signal converting/transmitting circuit 23 converts the digital signal input from the analog/digital converter 22 to a predetermined signal format suitable for wireless transmission and at the same time, subjects the digital signal to radio modulation and outputs the resultant to the signal transmission antenna 26. Here, the predetermined signal format is suitably a serial format or the like, for instance, but need not be limited to a specific signal format and is to be set arbitrarily.

Further, the radio modulation may be a conventionally and publicly known modulation method such as digital amplitude modulation or digital phase modulation, and any modulation method may be selected. In the embodiment of the present invention, a frequency in a 3 MHz band is used as a radio frequency for transmission.

A carrier wave output resulting from the appropriate modulation as described above in the signal converting/transmitting circuit 23 is supplied to the signal transmission antenna 26.

The signal transmission antenna 26 in the embodiment of the present invention uses a circular coil which is wound a plurality of times but, needless to say, is not limited to such an antenna and may be an antenna having any other shape and so on.

The rectifying circuit 24 rectifies a power supply signal received by the power reception antenna 25 to supply power to the aforesaid analog/digital converter 22 and signal converting/transmitting circuit 23. For example, it is preferable that a capacitor with a relatively large capacitance (not shown) is provided in a power supply line (not shown) for supplying power to the analog/digital converter 22 and the signal converting/transmitting circuit 23 in parallel to the rectifying circuit 24 and the capacitor is used for the power supply in a so-called floating state, since this structure eliminates a need for constant power transmission by the power transmission head 32, which will be described later.

The power reception antenna 25 in the embodiment of the present invention, similarly to the signal transmission antenna 26, uses a circular coil which is wound a plurality of times but needless to say, is not limited to such an antenna and may be an antenna having any other shape and so on.

The control part 31 disposed near the dresser head 41 is formed mainly by a microcomputer (denoted by “CPU” in FIG. 2) 36 having a conventionally and publicly known structure and performs the operation control of the later-described power transmission head 32 and signal reception head 35, the signal format conversion of an input signal, and so on. Such a control part 31 operates when supplied with power from a DC power source (denoted by “DC POWER” in FIG. 2) 39 provided at an appropriate position of the grinding apparatus.

The signal reception head 35 performs demodulation, signal level conversion, and the like of a signal received by the signal reception antenna 34, that is, the above-described signal output from the signal converting/transmitting circuit 23 via the signal transmission antenna 26. Incidentally, a circuit itself for the demodulation and the signal level conversion here has a conventionally and publicly known structure generally used in communication apparatus and the like, and therefore, detailed description thereof will be omitted.

An output signal of the signal reception head 35 is output to a digital serial output circuit (denoted by “RS232C” in FIG. 2) 37 or an analog output circuit (denoted by “ANALOG” in FIG. 2) 38 via the control part 31.

Here, the digital serial output circuit 37 is a circuit for outputting serial digital data, which is a detected signal of the ultrasonic sensor 21 demodulated by the signal reception head 35, by RSC-232C which is a conventionally and publicly known interface standard. Further, the analog output circuit 38 is a circuit for converting the serial digital data, which is the detected signal of the ultrasonic sensor 21 demodulated by the signal reception head 35, to a predetermined analog voltage to output the analog voltage.

The output signals from the digital serial output circuit 37 and the analog output circuit 38 are used by a not-shown controller in position control and the like of the grinding wheel 6.

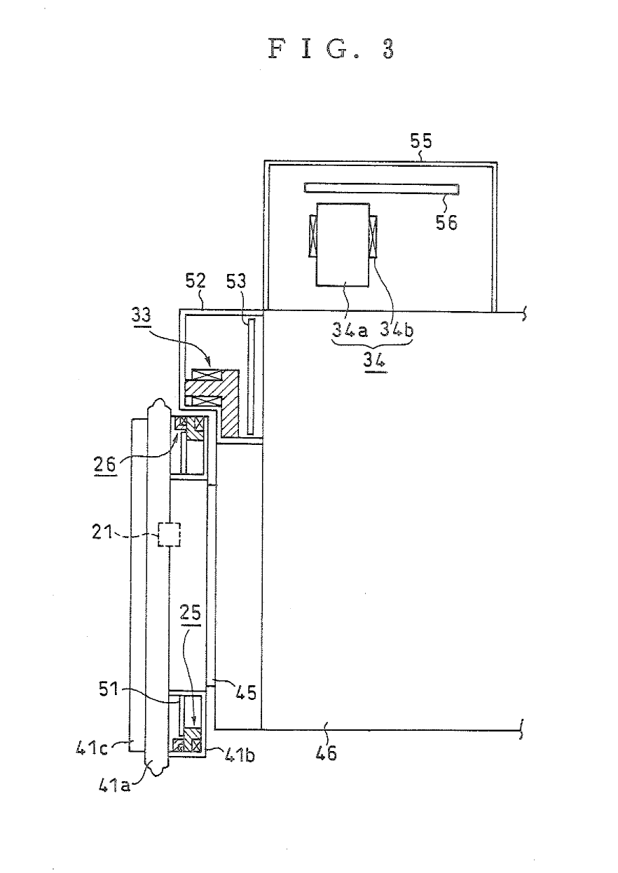

Next, a concrete layout example of mainly the power reception antenna 25, the signal transmission antenna 26, the power transmission antenna 33, and the signal reception antenna 34 will be described with reference to FIG. 3 to FIG. 5.

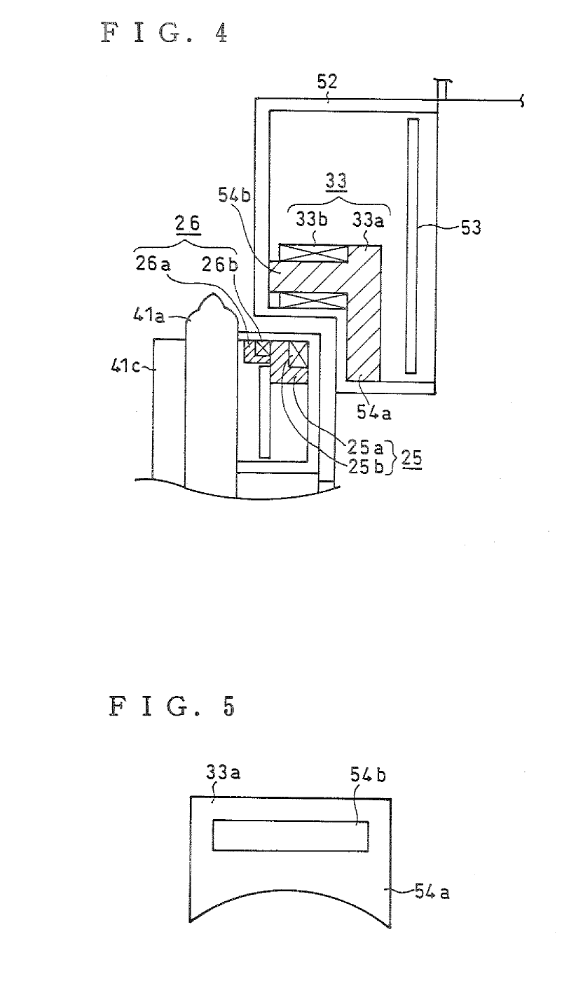

FIG. 3 schematically shows the overall layout and structure of mainly the power reception antenna 25, the signal transmission antenna 26, the power transmission antenna 33, and the signal reception antenna 34, and FIG. 4 schematically shows especially a portion where the power reception antenna 25, the signal transmission antenna 26, and the power transmission antenna 33 are disposed.

In this structure example, a holding member 41b on a rotating shaft 45 side rotating the dresser head 41 has a component housing space in an annular shape, and the component housing space houses the power reception antenna 25, the signal transmission antenna 26, and a dresser head circuit board 51 on which the aforesaid analog/digital converter 22, signal converting/transmitting circuit 23, and rectifying circuit 24 are provided (see FIG. 3 and FIG. 4). Incidentally, the ultrasonic sensor 21 is provided in the dresser head 41 so as to abut on a dresser main body 41a.

The power reception antenna 25 and the signal transmission antenna 26 in this structure example have different sizes but basically have the same structure. Specifically, the power reception antenna 25 and the signal transmission antenna 26 are composed of: a power reception core member 25a and a signal transmission core member 26a each having an annular entire shape and having a stepped portion for coil winding; and a power reception coil 25b and a signal transmission coil 26b each formed by a coil winding wound around the stepped portion for coil winding (see FIG. 4).

In the embodiment of the present invention, the power reception antenna 25 is slightly larger than the signal transmission antenna 26. The power reception antenna 25 and the signal transmission antenna 26 are provided in a stacked state, the former being positioned on the rotating shaft 45 side and the latter being positioned on the dresser main body 41a side (see FIG. 3 and FIG. 4).

At an appropriate position facing the dresser head 41 side of a casing 46 housing a motor (not shown) rotary-driving the dresser head 41, and so on, a power transmission head housing case 52 is provided to house the power transmission antenna 33 and a transmission head circuit board 53 on which an electronic circuit of the power transmission head 32 is mounted (see FIG. 3 and FIG. 4). Incidentally, the power transmission head housing ease 52 is preferably made of a member having a sufficient transmittance to an electromagnetic wave with a predetermined frequency emitted from the power transmission antenna 33 and having no shielding effect against the electromagnetic wave.

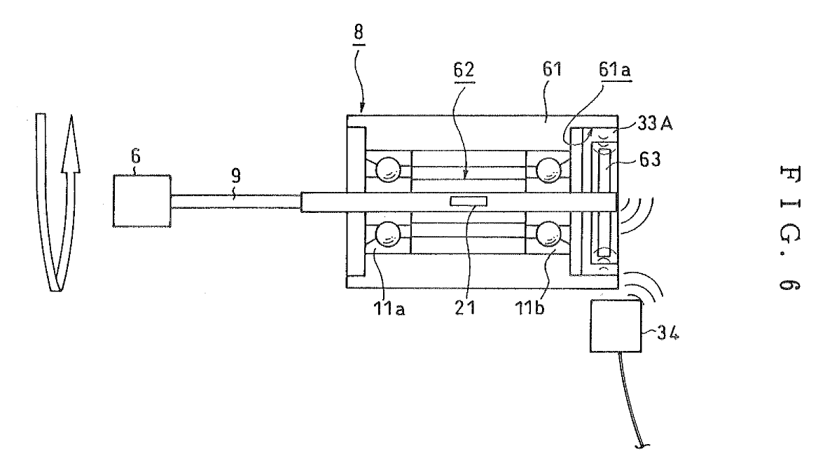

The power transmission antenna 33 in the embodiment of the present invention, similarly to the other antennas, is composed of a power transmission core member 33a and a power transmission coil 33b wound around the power transmission core member 33a. The power transmission core member 33a has a base portion 54a made of a magnetic material and a columnar portion 54b for winding integrally formed with and protruding from the base portion 54a (see FIG. 4). The base portion 54a, when seen from the dresser head 41 side, has a rectangular planar shape with a lower hem portion thereof, that is, with a portion closest to the dresser head 41 being cut in an arc shape (see FIG. 5). This is because of the following reason. Since the power transmission head housing case 52 is disposed extremely close to an outer peripheral edge of the dresser head 41, a lower side portion of the power transmission head housing case 52, that is, a portion facing the dresser head 41, is formed in an arc shape (not shown) so as to fit along the peripheral edge of the dresser head 41, and the aforesaid portion of the base portion 54a is made to correspond to this arc shape.

Further, near the power transmission head housing case 52, a signal reception head housing case 55 is fixedly provided on an appropriate position of the casing 46, and houses the signal reception antenna 34 together with a reception head circuit board 56 on which an electronic circuit forming the signal reception head 35 is mounted (see FIG. 3).

The signal reception antenna 34 in the embodiment of the present invention is composed of a signal reception core member 34a having an outer appearance in a substantially rectangular columnar shape and a signal reception coil 34b wound around the signal reception core member 34a.

Incidentally, similarly to the power transmission head housing case 52, the signal reception head housing case 55 is preferably made of a member having a sufficient transmittance to an electromagnetic wave with a predetermined frequency received by the signal reception antenna 34 and having no shielding effect against the electromagnetic wave.

In the embodiment of the present invention, the power transmission antenna 33 and the power reception antenna 25, and the signal transmission antenna 26 and the signal reception antenna 34 are disposed relatively close to each other, and therefore, regular signal transmission/reception by the propagation of the electromagnetic wave proceeds simultaneously with signal transmission/reception by electromagnetic coupling between the antennas.

Incidentally, in the above-described embodiment of the present invention, a first electronic circuit is realized by the analog/digital converter 22 and the signal converting/transmitting circuit 23, and a second electronic circuit is realized by the signal reception head 35. Further, a third electronic circuit is realized by the power transmission head 32.

Next, the overall operation of the detection-signal transmitting apparatus in the above-described structure will be described. First, the dresser head 41 dresses the grinding wheel 6, and if an ultrasonic wave is generated depending on a state of the dressing, the ultrasonic wave is detected by the ultrasonic sensor 21 provided in the dresser head 41. An analog signal according to the level of the detected ultrasonic wave is output from the ultrasonic sensor 21 and is input to the analog/digital converter 22 also provided in the dresser head 41, to be immediately converted to a digital signal. Then, the detected signal of the ultrasonic sensor 21 converted to the digital signal by the analog-digital converter 22 is subjected to radio modulation by the signal converting/transmitting circuit 23 to be applied to the signal transmission antenna 26, and is emitted as an electromagnetic wave.

The signal emitted from the signal transmission antenna 26 is input to the signal reception head 35 via the signal reception antenna 34, and the reception signal is subjected to demodulation, signal level conversion, and the like by the signal reception head 35.

Then, the signal resulting from the demodulation, the level conversion, and the like by the signal reception head 35 is input to the control part 31 to be output to an external part via the digital serial output circuit 37 or the analog output circuit 38 which is selected as required, and is used for position control of the grinding wheel 6, for instance.

Meanwhile, the power transmission head 32 is driven by the control part 31 at an appropriate timing and applies a power signal with a predetermined radio frequency to the power transmission antenna 33.

Consequently, the power signal is emitted from the power transmission antenna 33 and is input to the rectifying circuit 24 via the power reception antenna 25. Then, a rectified voltage obtained by the rectifying circuit 24 is applied as a power supply voltage to the analog/digital converter 22 and the signal converting/transmitting circuit 23 in the dresser head 41.

In the structure example described above, the ultrasonic wave can be detected in the dresser head 41, but this structure is not restrictive, and also suitable is, for example, a structure in which the ultrasonic wave can be detected in the wheel spindle 8 side.

FIG. 6 shows, as a second structure example, a structure example where the ultrasonic wave can be detected on the wheel spindle 8 side. Hereinafter, this structure example will be described with reference to FIG. 6. The same reference numerals and symbols are used to designate the same constituent elements as those of the structure example shown in FIG. 1 to FIG. 5, and detailed description thereof will be omitted. The following description will mainly focus on what are different.

A wheel spindle 8 in this structure example is structured such that a shaft driving built-in motor 62 is provided in a spindle casing 61, and a wheel shaft 9 is rotatably supported via bearings 11a, 11b provided near both end portions of the spindle casing 61, and such a structure is conventionally and publicly known.

In the embodiment of the present invention, a power transmission antenna 33A and a rotating casing 63 are provided between the bearing 11b on a rear end side of the spindle casing 61 and a rear end surface of the spindle casing 61.

A power transmission antenna 33A in this structure example is formed to have a substantially C-shaped vertical cross section (see FIG. 6), to have a disk-shaped whole appearance when seen from an end portion side of the wheel shaft 9, and to allow the wheel shaft 9 to pass through its center portion, and the power transmission antenna 33A is fixed to a recessed portion 61a formed on the rear end portion side of the spindle casing 61. For simplicity and easier understanding of the drawing, detailed illustration of a coil and a core member of the power transmission antenna 33A is omitted in FIG. 6.

In the rotating easing 63, a signal transmission antenna 26, an analog/digital converter 22, a signal converting/transmitting circuit 23, and a rectifying circuit 24, though not shown, are housed.

The rotating casing 63 of the present invention is fixed to the wheel shaft 9 and is provided to be rotatable with the wheel shaft 9.

Further, the length of the rotating casing 63 in a diameter direction of the wheel shaft 9 is set smaller than that of the power transmission antenna 33, and the rotating casing 63 is fixed to the wheel shaft 9 so as to be positioned inside a C-shaped portion of the power transmission antenna 33.

An ultrasonic sensor 21 is attached at an appropriate portion of an outer peripheral surface of the wheel shaft 9.

Near the rear end side of the wheel spindle 8 as structured above, a signal reception antenna 34 is fixedly provided at a not-shown fixed portion of the grinding apparatus.

The basic operation as the detection-signal transmitting apparatus in the above-described structure is the same as that previously described in the structure example shown in FIG. 1 to FIG. 5, and therefore detailed description thereof will not be repeated here.

In the embodiment of the present invention, the example is shown where the detection-signal transmitting apparatus detecting and transmitting an ultrasonic wave generated in the dressing work is provided in the grinding apparatus having the grinding section 101 and the dresser section 102, but it goes without saying that the detection-signal transmitting apparatus is similarly applicable in a specialized dresser apparatus.

Further, the ultrasonic wave detected and transmitted is not limited to that generated in the dressing work, but it goes without saying that a structure where the ultrasonic wave generated in the grinding of a work is similarly detected and transmitted is also adoptable.

The detection-signal transmitting apparatus according to the present invention is capable of converting a detected signal to a digital signal at a detection place to wirelessly transmit the converted detected signal and is also capable of supplying power necessary for the digital signal conversion and the like by wireless transmission, and therefore is suitable for the detection and transmission of an ultrasonic wave in a rotating body, for example, a dresser head and the like.

According to the present invention, the output signal of the ultrasonic sensor is converted to the digital signal immediately at a position where the ultrasonic sensor is provided, before the output signal is output to a transmission path, and the digital signal is wirelessly transmitted. As a result, a greater improvement in an S/N ratio of the detected ultrasonic signal is achieved than has been conventionally achieved.

Further, since, unlike a conventional one, this apparatus can transmit the detected ultrasonic wave to an external part of the rotating body without using a component such as a slip ring which restricts the rotation speed of the rotating body, it is possible not only to easily increase the speed of the rotating body but also to eliminate a need for a component such as the slip ring which wears away and is damaged more in accordance with the increase in the speed of the rotating body and thus requires frequent replacement, and therefore, a highly reliable detection-signal transmitting apparatus can be provided.

Further, since the detected ultrasonic wave is wirelessly transmitted, high precision in setting an interval between a transmitting side and a receiving side as has been conventionally required is not required, and high machining precision of a used component itself as has been required in the conventional art is not required, which brings about an effect that a lower-priced and more stable detection-signal transmitting apparatus can be provided.

1-5. (canceled)

6. In a detection-signal transmitting apparatus detecting and transmitting an ultrasonic wave generated in a rotating body,
the apparatus including, in the rotating body: an ultrasonic sensor detecting the ultrasonic wave; an analog/digital converter converting a detected signal of the ultrasonic sensor to a digital signal; a signal converting/transmitting circuit subjecting an output signal of the analog/digital converter to radio modulation; a signal transmission antenna emitting the signal resulting from the radio modulation by the signal converting/transmitting circuit; a power reception antenna receiving a power signal with a radio frequency transmitted from an external part; and a rectifying circuit rectifying the signal obtained by the power reception antenna to supply power,
the apparatus further comprising: a signal reception antenna receiving the signal emitted from the signal transmission antenna; a signal reception head performing demodulation and signal level conversion of the reception signal obtained by the signal reception antenna; a power transmission head generating the power signal with the radio frequency; a power transmission antenna emitting the power signal with the radio frequency applied from the power transmission head; and a control part controlling operations of the signal reception head and the power transmission head and performing signal conversion,
wherein the signal transmission antenna and the power reception antenna are each composed of a core member formed in an annular shape and a coil winding wound around the core member and are disposed in a stacked manner, and
wherein the power transmission antenna is provided near an outer peripheral edge of the power reception antenna.

7. The detection-signal transmitting apparatus according to claim 6,
wherein the signal reception antenna is composed of a signal reception core member formed in a rectangular columnar shape and a signal reception coil wound around the signal reception core member, and is provided outside a casing housing a motor rotary-driving the rotating body.

8. The detection-signal transmitting apparatus according to claim 7, wherein the rotating body is a dresser head used in a dressing work.

9. The detection-signal transmitting apparatus according to claim 8, wherein the control part causes the power transmission head to transmit the power signal with the radio frequency at a timing different from an operation timing of the signal reception head.

10. The detection-signal transmitting apparatus according to claim 9, wherein a large-capacity capacitor is provided in a power supply line for supplying power to the analog/digital converter and the signal converting/transmitting circuit in parallel to the rectifying circuit, thereby enabling the power supply by the rectifying circuit in a floating state.
